(19) United States
(12) Patent Application Publication
(10) Pub. No.: US 2019/0074744 A1
(43) Pub. Date: Mar. 7, 2019

(54) STARTER MOTOR AND GENERATOR INCLUDING STACKED PRINTED CIRCUIT BOARDS

(71) Applicant: Briggs & Stratton Corporation, Wauwatosa, WI (US)

(72) Inventors: Robert J. Koenen, Pewaukee, WI (US); Jason A. Hansen, Elkhorn, WI (US)

(73) Assignee: Briggs & Stratton Corporation, Wauwatosa, WI (US)

(21) Appl. No.: 16/114,914

(22) Filed: Aug. 28, 2018

Related U.S. Application Data
(60) Provisional application No. 62/553,220, filed on Sep. 1, 2017.

(51) Int. Cl. H02K 3/26; H02K 11/00; H01F 5/00; F02N 11/08

(52) U.S. Cl. CPC H02K 3/26; H02K 11/0094; H02K 2211/03; F02N 11/08; H01F 5/003

(57) ABSTRACT

A device including a number of printed circuit board layers assembled in a stack that functions as a starting device for an internal combustion engine. Each of the circuit board layers includes a number of loops formed by copper traces on a dielectric substrate and each oriented in a coiled pattern. A rotor, which may take the form of a flywheel, is closely spaced from the stack of printed circuit board layers and includes a series of permanent magnets. When alternating current is supplied to the circuit board layers, the magnetic fields created by the loops induce rotation of the rotor. The device can operate in an alternator mode in which the device generates current as the rotor rotates past the loops on the circuit board during operation of the internal combustion engine.

### CROSS REFERENCE TO RELATED APPLICATION

The present application is based on and claims priority to U.S. Provisional Patent Application Ser. No. 62/533,220 filed Sep. 1, 2017, the disclosure of which is incorporated herein by reference.

### BACKGROUND

The present disclosure generally relates to an electric device for use with an internal combustion engine. More specifically, the present disclosure relates to an electric device that can function as a starting device for an internal combustion engine and includes a stack of a number of printed circuit board layers that each includes copper traces configured in multiple loops that function as a stator and impart rotation to a rotor. In addition, the present disclosure relates to a stack of a number of printed circuit board layers that can be used not only as a starting device to start an internal combustion engine but also as a generator during operation of the internal combustion engine.

Electric motors, such as a starter motor for an internal combustion engine, typically include a stator having multiple windings of conductive wire, such as copper, that receive an alternating electric current. A rotor positioned within the windings includes permanent magnets oriented in a specific configuration such that application of electric current to the stator windings causes the rotor to rotate. The windings that form the stator can be expensive to manufacture and are of a size that requires a certain amount of space in the engine compartment.

### SUMMARY

The present disclosure relates to a device for use with an internal combustion engine that can function as both a starter motor and an alternator. The device includes a rotor, which may take the form of a flywheel that is mounted to the crankshaft of the internal combustion engine. In some embodiments, the rotor includes a number of permanent magnets spaced along the outer circumference of the rotor.

A number of printed circuit board layers are oriented in a relationship with each other to create a stack. Each printed circuit board layer includes a number of copper loops printed in a manner to resemble a two dimensional coil. When current is supplied to the copper loops, the printed pattern creates a magnetic field in one of two opposing directions. The copper loops are spaced and oriented such that every other copper loop creates a magnetic field in the same direction.

A power supply can be selectively connected to the printed circuit board layers to supply current to the loops in alternating first and second directions. The first and second directions are opposite to each other such that the magnetic field created by each of the loops is alternating. The alternating supply of current creates alternating magnetic fields, which induces rotation of the rotor. Rotation of the rotor causes rotation of the crankshaft to start the internal combustion engine.

During operation of the internal combustion engine, the rotation of the permanent magnets of the rotor past the loops of the printed circuit board layers will induce current flow in the loops. This induced current can be provided to an AC/DC converter and thus will function as an alternator during operation of the internal combustion engine.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an electrical schematic illustration of the stacked printed circuit board layers that function as an alternator and as a starting device to start operation of an internal combustion engine according to some embodiments;

FIG. 2 is a schematic view illustrating the traces formed on one of the printed circuit board layers that form multiple loops to create magnetic fields according to some embodiments;

FIG. 3 is a perspective view showing the printed circuit board including the multiple loops and a control board according to some embodiments;

FIG. 4 is a perspective view of the stacked printed circuit board layers located relative to a flywheel of an internal combustion engine according to some embodiments;

FIG. 5 is a view showing the removal of the flywheel from the stacked printed circuit board layers according to some embodiments;

FIG. 6 is a top view showing the mounting of at least one control board and multiple batteries to the printed circuit board according to some embodiments;

FIG. 7 is a perspective view of permanent magnets included in the flywheel according to some embodiments;

FIG. 8 is a magnified view showing the spacing between the magnets of the flywheel and the traces formed on the printed circuit board layer according to some embodiments;

FIG. 9 is an electrical schematic illustration of an alternate embodiment in which the stacked printed circuit board layers function as both a starter motor and a generator according to some embodiments; and

FIG. 10 is an electric schematic illustration showing the interconnections between the stacked printed circuit board layers according to some embodiments.

### DETAILED DESCRIPTION

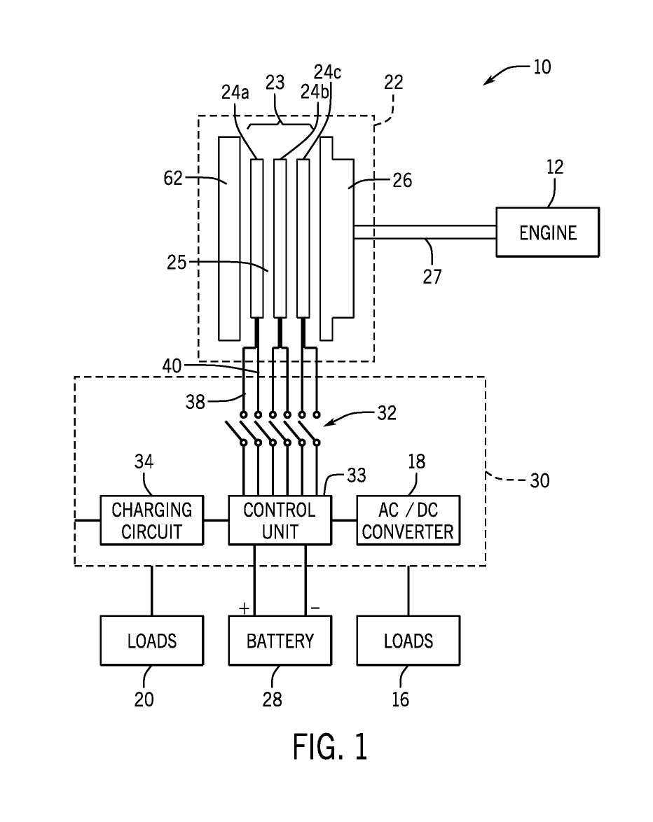

FIG. 1 illustrates the power system 10 for use in a wide variety of applications. The power system 10 includes an internal combustion engine 12 that can be used in a wide variety of different applications, such as with lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, sprayers, spreaders, etc. As one illustrated example, the internal combustion engine 12 can be used on a riding lawn tractor.

As illustrated in FIG. 1, an electric device 22 is used to start the internal combustion engine 12. Unlike typical starter motors that include a stator having wire loops, the electric device 22 of the present disclosure is constructed utilizing a series of printed circuit board substrate layers 24a-24c that are assembled in a layered stack 23. Each of the printed circuit board layers 24a-24c is spaced from the adjacent printed circuit board layer by an insulation layer 25, which can be an air gap. Other insulators could also be used in place of the air gap as long as the printed circuit board layers are electrically isolated from each other. In contemplated, alternate embodiments, the layered stack 23 could be either separate printed circuit boards that each define one of the layers or could be one individual printed circuit board that includes multiple layers. In either embodiment, an air gap or other form of insulation would exist between the layers of the circuit board substrate material and the electric device 22 would operate in the manner to be discussed below.

A rotor, which is shown in FIG. 1 as flywheel 26, is positioned near one end of the stack 23. Although the rotor is shown in the drawing figures as a flywheel 26, the rotor could be separate from the flywheel 26. The flywheel 26 includes a series of permanent magnets spaced about an outer circumference and is connected to the crankshaft 27 of the internal combustion engine 12. As will be discussed below, when power from a power supply, such as the battery 28, is connected to the individual printed circuit boards, current flowing through the copper traces on the circuit boards 24 may induce alternating magnetic fields which induce rotation of the flywheel 26. Rotation of the flywheel 26 is transferred to the crankshaft 27, which results in starting of the internal combustion engine 12.

The power system 10 shown in FIG. 1 includes a controller 30. The controller 30 includes a control unit 33, which may be a microprocessor, which is operable to control a wide variety of functions, including the state of one or more switching elements 32. The operating state of the switching elements 32 controls the application of power (e.g. voltage and current) to the individual circuit boards 24a-24c from the battery power supply 28. In one contemplated embodiment of the present disclosure, each of the switching elements 32 is a high current MOSFET that can transition between an open and closed position through control commands from the control unit 33. Although a MOSFET is described in one embodiment as the switching element 32, it should be understood that different types of switching elements, such as an SCR, transistor, IGBT or a relay, could be utilized while operating within the scope of the present disclosure.

As will be discussed in greater detail below, the control unit 33 can operate to control the position of the switching elements 32 as well as other interconnecting switches.

In one embodiment, the battery 28 shown in FIG. 1 may be a lithium ion battery pack. However, it is also contemplated that the battery 28 may include other battery types, such as lead acid, nickel cadmium, etc. In still other embodiments, the battery 28 may include other energy storage device types, such as super capacitors, fuel cells, etc. Where the battery 28 is a lithium ion battery pack, the battery 28 may include a number of individual lithium ion cells. In some embodiments, the individual lithium ion cells may have a voltage of approximately 4.1 volts. However, the voltage of the individual cells may also be more than 4.1 volts or less than 4.1 volts, depending on the configuration of the cells. The cells may be combined to increase an electrical voltage (e.g. connected in series) and/or to increase energy capacity (e.g. connected in parallel). For example, if three individual 4.1V cells are connected in series, the battery output voltage would be approximately 12.3-volts. Similarly, if two individual cells are connected in series, the output voltage from the battery 28 would be approximately 8.2-volts. An 8.2 V battery 28 may be sufficient to start an internal combustion engine 12 that would otherwise have included a typical 12-volt starter motor.

In the embodiment shown in FIG. 1, a charging circuit 34 can be used to provide external charging power to the battery 28 through the control unit 33. As an example, the charging circuit 34 could include a USB-C connector that will allow the battery 28 to be charged from a wall socket using a cell phone, or other electronic charging device. In other embodiments, the charging circuit 34 may be self-contained and allow for a direct connection to a standard 120 VAC power outlet.

The control unit 33, battery 28, AC/DC converter 18 and charging circuit 34 could be mounted to a common circuit board and the battery cells of the battery 28 could be either removable or permanently affixed to the circuit board.

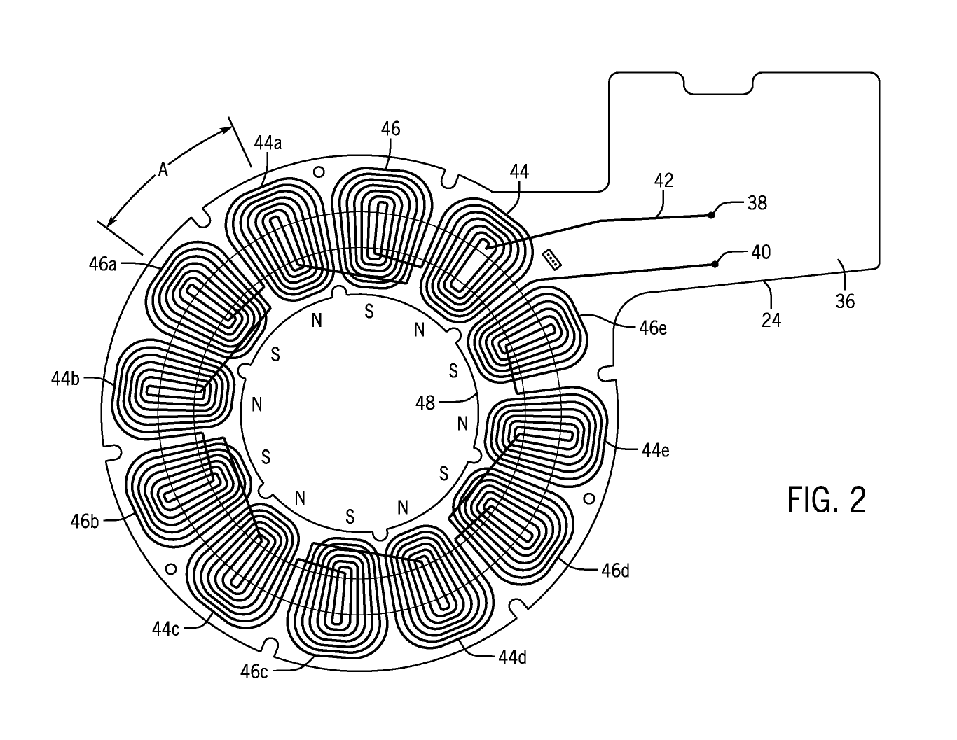

Referring now to FIG. 2, there shown is a front view of one of the printed circuit board layers 24. The printed circuit board layer 24 includes a dielectric substrate 36 having a pair of power connection leads 38 and 40. The first power lead 38 includes an electrical trace 42 that leads to a first loop 44 that is formed as a trace of copper printed on the dielectric substrate 36. The first loop 44 is configured in a pattern in which a flow of current from the connection lead 38 would flow in a first, counterclockwise direction through the first loop 44. The flow of current from the connection lead 38 creates a magnetic field having a first polarity. The first loop 44 is connected to a second loop 46 that is formed as a trace of copper printed on the dielectric substrate 36. The second loop 46 has a printed pattern in which the flow of current from the connection lead 38 would flow in a second, clockwise direction. The flow of current from the connection lead 38 creates a magnetic field having a second, opposite polarity to the first loop 44. In this manner, the first loop 44 and the second loop 46 function to create magnetic fields having opposing polarities. In some embodiments, the first loop 44 and the second loop 46 may be pre-formed copper loops that are soldered or otherwise coupled to the printed circuit board 24. Using pre-formed copper loops can allow for loops to be utilized that can handle greater currents than copper loops printed directly onto a printed circuit board, which may allow for the elimination of multiple printed circuit board layers

Loops 44a, 44b, 44c, 44d and 44e are all configured to have the same pattern as the first loop 44 described above and in the same direction and are spaced from each other by coils 46a, 46b, 46c, 46d and 46e, which have the same pattern as the second loop 46 described above. In this manner, the printed circuit board layer 24 creates an alternating pattern of north and south poles along the circular opening 48 defined by the circuit board layer 24 when current is supplied through the connection lead 38. In some alternate embodiments, the coil patterns may not alternate (i.e. all of the coils could be in the same clockwise or counter-clockwise direction). In such embodiments, the stack of circuit board layers would be configured such that a printed circuit board layer having all of the coils configured in a first pattern would be positioned next to a printed circuit board layer having all of the coils configured in a second, opposite pattern. In still other embodiments, multiple printed circuit board layers may be stacked having the coils all configured to be coiled in the same direction, i.e. all clockwise or all counterclockwise. In this embodiment, the printed circuit board layers may be configured such that the coils of each printed circuit board layer are offset from the coils of the one or more adjacent printed circuit board layers by a predetermined offset angle. In one example, the offset angle may be one-third of the angular relationship of the coils on the printed circuit board layers. Thus, if the printed circuit board layers have twelve coils each, the angular relationship between them would be thirty degrees (assuming equidistant spacing), and therefore the offset for the subsequent printed circuit board layer would be ten degrees (e.g. the coils of the second printed circuit board layer would be offset ten degrees from the coils of the first printed circuit board layer. This could carry on for each of the multiple stacked printed circuit board layers. This configuration may be used when the printed circuit board layers are configured to operate as a starter motor to allow for multiphase voltage generation. The above example is illustrative only, and it is contemplated that the number of coils and/or the offset angles may include other values than those described above.

When current is supplied to the connection lead 38, the current flows through the series of loops 44 and 46 and finally out through the connection lead 40. During operation as a starter motor, the flow of current can be reversed by applying current to the connection lead 40, which reverses the polarity of the magnetic field created by each of the loops 44 and 46. Current would then leave the printed traces through the connection lead 38. In this manner, the polarity of the magnetic fields created by the loops 44 and 46 can be alternated. In the embodiment shown in FIG. 2, the printed circuit board 24 has six pairs of loops where each pair of loops is separated by an angle A shown in FIG. 2.

Although the circuit board layer 24 shown in FIG. 2 includes six pair of loops each having a first and a second polarity, the printed circuit board layer 24 could be configured to have either three pair of loops or nine pair of loops depending upon the specific embodiment. For example, in three phase motors and/or alternators, there is generally a 3-to-4 ratio between the coils and the permanent magnets. As an illustrative example, three coils would correspond to four magnets; six coils to eight. Additionally, printed circuit board layers can be used together in a stacked relationship where some of the circuit board layers include three pair of loops, some include six pair of loops while others include nine pair of loops.

As shown in FIG. 1, the connection leads 38 and 40 for each of the printed circuit board layers 24a-24c are connected to the battery 28 through separate switching elements 32. In this manner, the control unit 33 can control the direction of current flow through the loops 44 and 46 by controlling the state of each of the switches 32.

Referring back to FIG. 1, the electric device 22 of the present disclosure includes three circuit board layers 24a, 24b and 24c positioned on top of each other and separated by the insulation layer 25 to form the stack 23. The insulation layer 25 is configured to provide sufficient insulation and electrical isolation between the circuit board layers. However, the electric device 22 will have a very flat configuration as compared to starter motors that include conventional coils and windings.

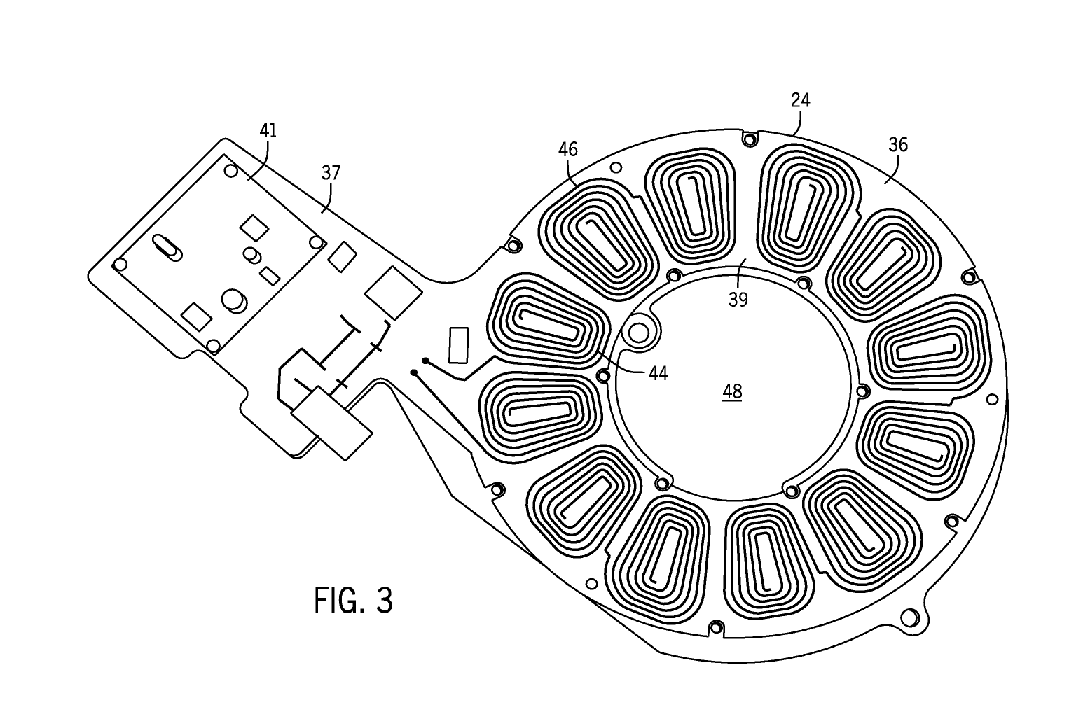

Referring now to FIG. 3, dielectric substrate 36 that forms the printed circuit board layer 24 may include control circuit portion 37 that is connected to and formed integrally with a winding portion 39. The winding portion 39 has a toroid shape that defines opening 48. The printed loops 44 and 46 are spaced around the opening 48. The control circuit portion 37 provides additional circuit board area to mount and connect various operating components, such as the engine control unit (ECU) 41 and various other electric components needed for operating the internal combustion engine and associated electrical systems. Alternatively, the various circuitry could be a permanent part of the printed circuit board (e.g. the control circuit portion 37 could be configured to integrate traces and components direction onto the control circuit portion 37).

As can be understood when referring to FIG. 3, when the ECU 41 is integrated with the control circuit portion 37, a series of wire harnesses can be eliminated that would typically have been required to operate the starter motor. The elimination of wiring harnesses within the internal combustion engine reduces the cost of the internal combustion engine by not only eliminating the wireless harnesses but also eliminating additional circuit board mounts and connectors.

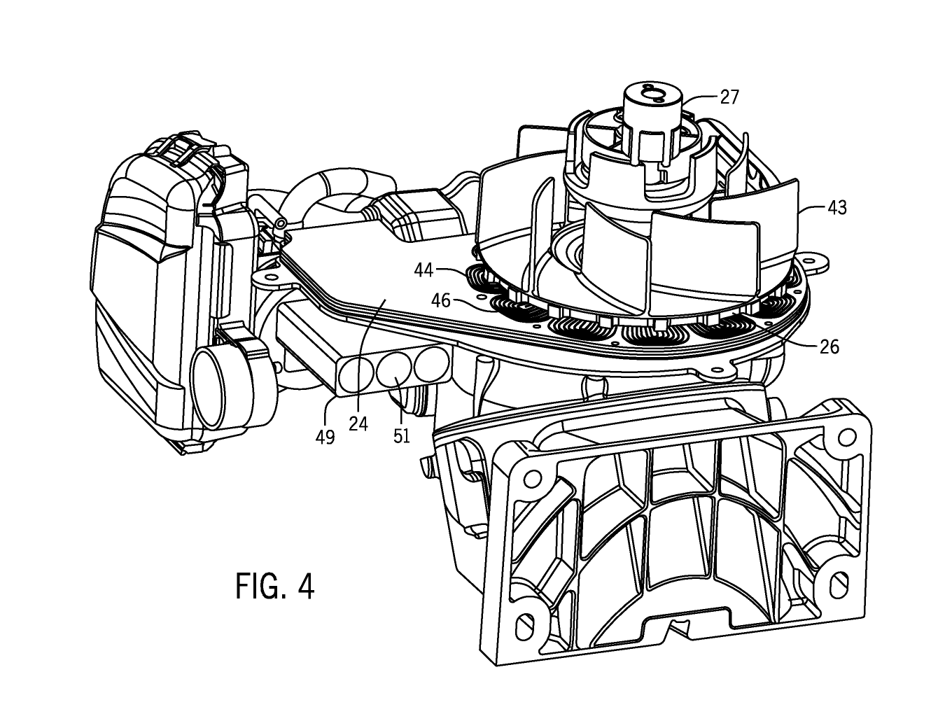

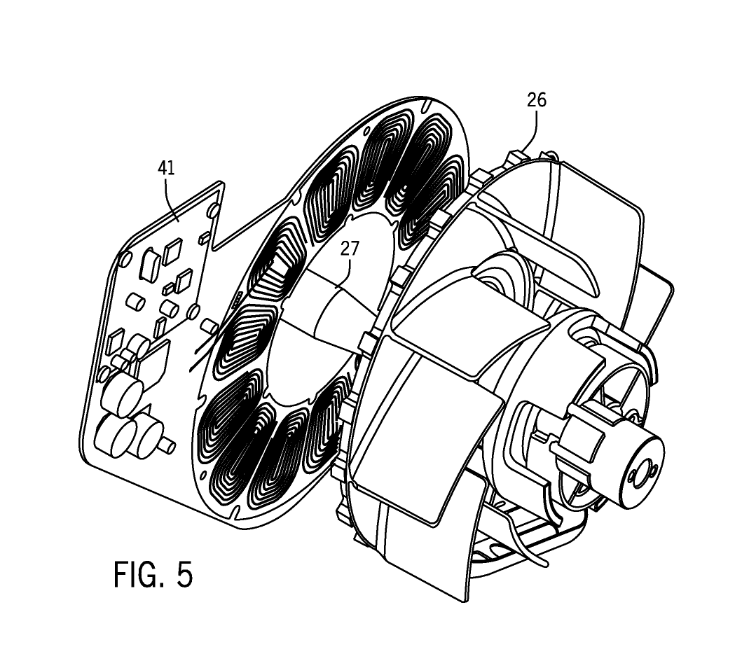

FIG. 4 illustrates the three circuit board layers 24 stacked on top of each other in a configuration that can induce rotation of the flywheel 26 and an associated fan 43. The flywheel 26 is connected to the crankshaft 27 of the internal combustion engine, as can be seen in both FIGS. 4 and 5.

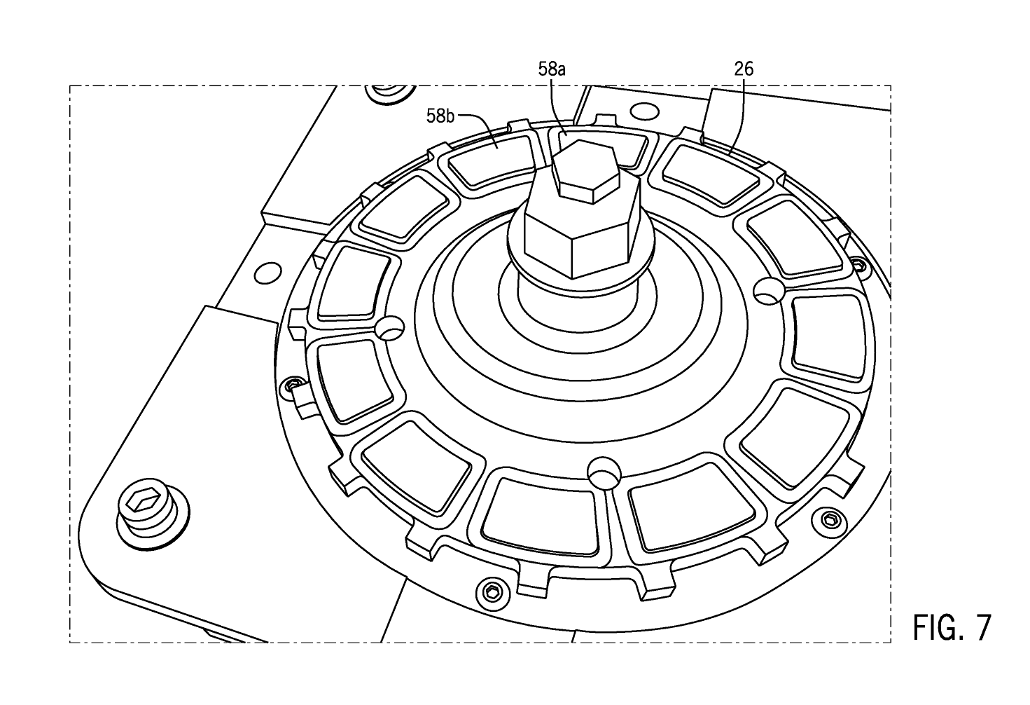

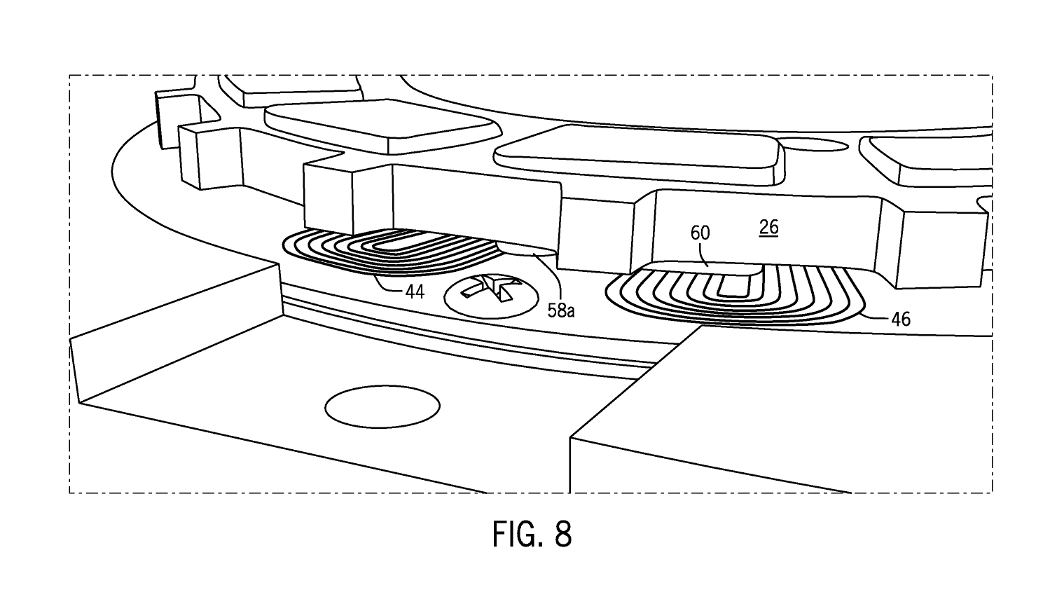

The flywheel 26 is more clearly shown in FIG. 7. The flywheel 26 includes a series of permanent magnets 58 spaced around the outer circumference of the flywheel. The permanent magnets 58 have opposite polarities such that permanent magnet 58a has a first polarity while the permanent magnet 58b has a second, opposite polarity. Although the magnets and rotor are shown as being part of the flywheel 26, the magnets/rotor could be separate from the flywheel 26 in alternate, contemplated embodiments. In such an embodiment, both the flywheel 26 and the separate rotor would be mounted to the crankshaft 27. Further, it is contemplated that permanent magnets of the rotor could be eliminated and replaced by an inductive component, such as a steel bar. As can be understood in the comparison between FIGS. 3 and 7, the electric device of the present disclosure includes the same number of wire loops 44, 46 as permanent magnets 58. In the embodiment illustrated, the printed circuit board 24 includes twelve wire loops while the flywheel 26 includes twelve permanent magnets 58. The angular spacing between the permanent magnets 58 corresponds to the spacing between the loops 44, 46. As can be seen in FIG. 8, the inner face 60 (e.g. face closest to the circuit boards 24) of each of the permanent magnets 58 is closely spaced from the circuit board trace that forms one of the loops 46. As can be understood in FIG. 8, when current is supplied through the printed traces that form the loops 44, 46, the loops 44, 46 create a magnetic field that attracts one of the permanent magnets 58a and repels the other permanent magnet 58b. By controlling the application of current to the electric traces formed on the printed circuit board, the control unit can create rotation of the flywheel 26. Since the flywheel 26 is mounted to the crankshaft 27, the induced rotation of the flywheel 26 rotates the crankshaft and can initiate operation of the internal combustion engine.

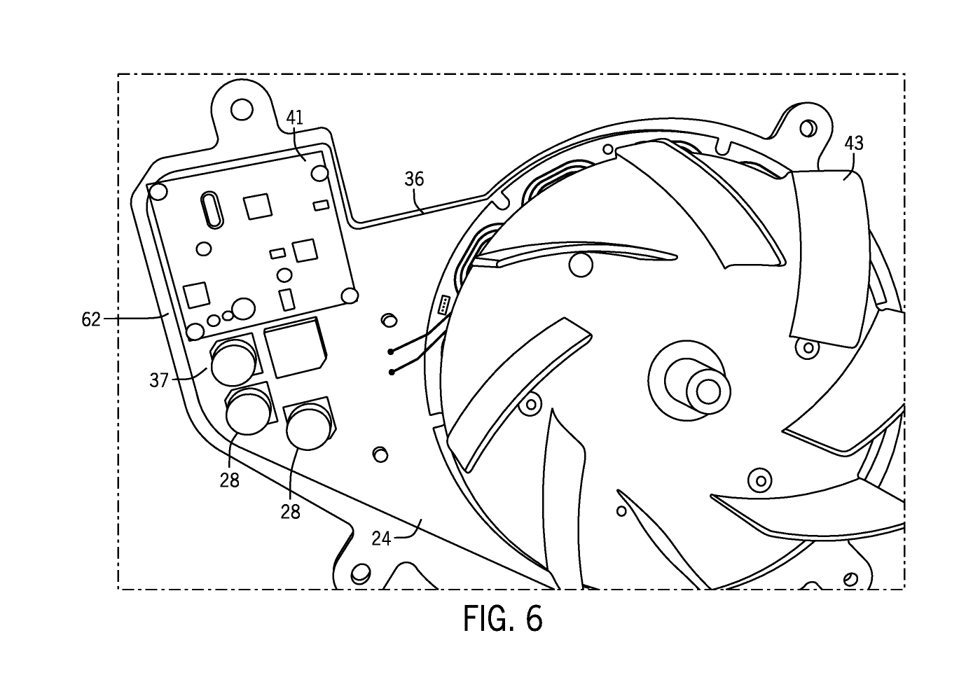

As shown in FIG. 6, the control circuit portion 37 of the printed circuit board is sized to support various different operating components, which can include the ECU 41. Although the ECU 41 is shown in FIG. 6, it should be understood that the area provided by the control circuit portion 37 can be used to integrate or mount various different operating controls and devices.

As an example, a battery holder 49 is shown in FIG. 4 mounted to the printed circuit board in the control circuit portion 37. The battery holder 49 includes three battery slots 51 that each are sized to receive a battery cell. In another contemplated embodiment, the battery holder 49 could be eliminated and the battery could be incorporated directly into the control circuit portion 37 of the printed circuit board. Such embodiment would eliminate the need for external conductors and would reduce the cost of the system.

It is also contemplated that various components such as a voltage regulator or other control circuitry used in controlling the operation of the internal combustion engine 12 could be mounted on or integrated into the PCB in the control circuit portion 37. In an embodiment that includes the battery integrated directly onto the PCB, the battery monitoring system (BMS) could be baked into the circuit board and thus would reduce the cost of the entire system. Although each of the multiple printed circuit boards 24 are shown as including the control circuit portion 37, it should be understood that only one of the printed circuit boards 24 may include the control circuit portion 37 while the other stacked PCB's could have a slightly different configuration.

In the embodiment shown in FIG. 6, a steel backing plate 62 may be located at an opposite side of the stacked printed circuit boards from the rotating flywheel 26. The backing plate 62 is also shown in FIG. 1. The backing plate 62 may be configured to direct the magnetic field created by the loops 44, 46 to the permanent magnets of the flywheel.

Although the backing plate 62 is shown in the drawing figures as being a sheet of steel, in another embodiment of the present disclosure, the backing plate 62 could be replaced with a backing plate including a series of permanent magnets. The permanent magnets included in such a backing plate would be spaced in the same manner as previously described with respect to the flywheel 26 and shown in FIG. 7. The use of permanent magnets in the backing plate 62 would need to rotate with the flywheel 26 and would enhance the magnetic field created by the permanent magnets formed in the flywheel and the magnetic field created by the individual loops 44, 46 formed on each of the printed circuit boards 24. However, such embodiment would increase the complexity of the system since the rotating backing plate would need to be closely spaced from the individual loops formed on the printed circuit board layer 24.

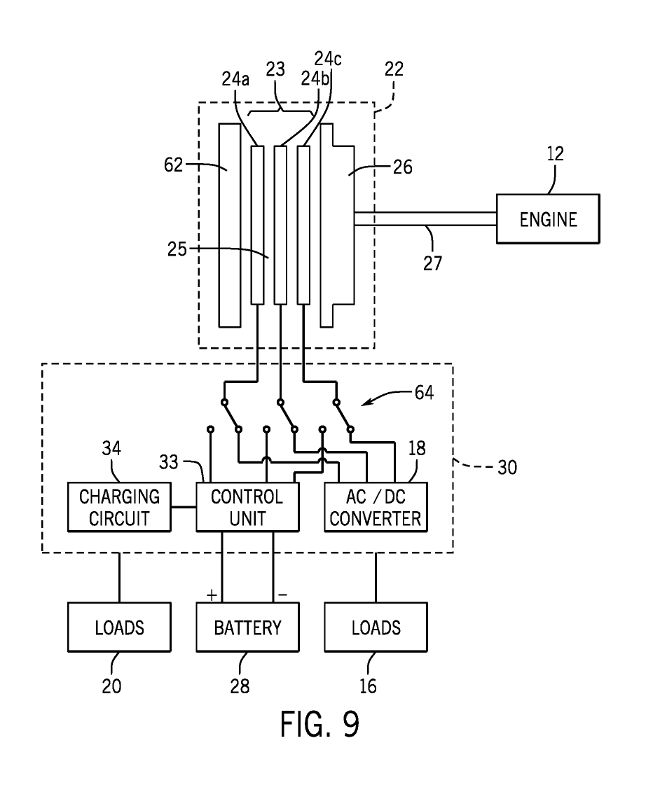

FIG. 9 illustrates an alternate arrangement in which the series of stacked printed circuit board substrate layers 24a, 24b and 24c of the electric device 22 can operate not only as the starter motor for the internal combustion engine 12 but also can function to generate current and voltage, in the same manner as an alternator. As can be understood by the previous description, once the internal combustion engine 12 starts to operate, the rotation of the permanent magnets contained within the flywheel 26 will induce current in the individual loops 44, 46 formed on the printed circuit board layers 24a, 24b and 24c. The control unit 33 can control the position of a series of multi-position switches 64 to disconnect the stacked printed circuit board layers 24 from the battery 28 and instead connect the printed circuit board layers to the AC/DC converter 18. Rotation of the flywheel 26 will induce an alternating current in each of the stacked printed circuit board layers 24, which can then be provided to the AC/DC converter 18. The AC/DC converter 18 will thus function to provide a source of DC voltage, which can be used to power the loads 16 and 20. These loads may include the ECU, a charging circuit, lights, gauges, control systems, and the like. Under specific designs and configurations, the output from the controller 30 could be 120 volts AC and be left as AC for use as a generator.

Although a separate alternator is not shown in the embodiment of FIGS. 1 and 9, it should be understood that a separate alternator could also be included. However, by utilizing the stacked printed circuit board layers 24 of the electric device 22 as not only the driving force in a starter motor application but also as a generator of current during operation of the internal combustion engine 12, components can be removed or eliminated from a typical starting circuit, such as a separate alternator.

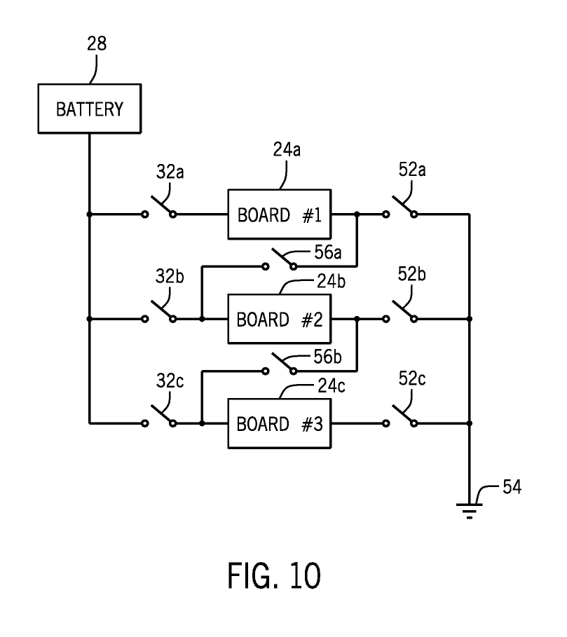

Referring now to FIG. 10, the windings on the three printed circuit board layers 24a, 24b and 24c can be connected either in series or parallel. To connect the printed circuit board layers 24a-24c in parallel, the switches 32a-32c can be selectively closed by the control unit (not shown). At the same time, the switches 52a-52c can be closed to connect each of these circuit boards to ground 54. Connecting the circuit board layers 24a-24c in parallel can allow for additional capacity (e.g., power) to be generated.

Alternatively, if it is desired to connect the circuit boards in a series relationship, the interconnecting switches 56a and 56b can be closed. At the same time, switch 32a is closed along with switch 52c. Switches 32b, 32c, 52a and 52b remain open such that the circuit board layers 24a, 24b and 24c are connected in series. Once again, control unit controls the operational state of each of the switches 32a-32c, 52a-52c and 56a-56b. Connecting the circuit board layers 24a-24c in series can allow for higher voltages to be generated.

As can be understood in FIG. 10, the control unit can actively control whether the individual circuit board layers are connected in series or parallel. Additionally, the control unit can remove any one of the circuit board layers 24a-24c from the parallel connection by selectively opening and closing the switches 32a-32c and 52a-52c. Removing one or more of the circuit board layers 24a-24c would be desirable when the electric device 22 is being used as an alternator to control the current and voltage output from the stack of circuit board layers. As an example, the current output from the stack of circuit board layers is dependent upon the rotational speed of the flywheel 26. At high speeds, the amount of current output may exceed the rating of the AC/DC converter. In such a situation, one or more of the circuit board layers could be removed from the parallel connection to reduce the amount of current generated.

As an illustrative example, all of the circuit board layers 24a-24c can be connected in a parallel relationship to start the internal combustion engine. Once the internal combustion engine starts, one or more of the circuit board layers 24a-24c could be removed depending upon the operational requirement for the electric device.

As discussed with reference to FIG. 9, the stacked printed circuit board layers 24 may be used as both a starter motor to cause rotation of the flywheel 26 and as an alternator to generate an AC voltage and current during normal operation of the internal combustion engine. As an illustrative example, when the engine is running at 1000 RPMs, a voltage of X is generated and supplied to the AC/DC converter 18. If the speed of rotation of the internal combustion engine increases by a factor of three to 3000 RPM's, the voltage will also increase by a factor of three. During normal operation of the internal combustion engine 12 when the stacked printed circuit board layers 24 are being used as a generator, the printed circuit board layers will be connected in series. However, if the speed of the engine dramatically increases, which results in a much larger voltage, the printed circuit board layers 24 could be connected in parallel to greatly reduce the voltage while at the same time increasing the current output of the stacked printed circuit board layers. The control unit can control the series of switches 32a-32c, 52a-52c and 56a-56b to connect the printed circuit board layers 24a-24c in either the desired parallel or series configuration.

In the embodiment shown in the drawing figures each of the printed circuit board layers 24 includes a dielectric substrate 36 that includes a series of loops 44, 46 that are typically copper traces printed onto the substrate 36. However, in alternate embodiments, the printed copper traces could be replaced by stamped copper sheets that have a slightly increased thickness. The use of stamped copper sheets in place of the printed copper traces will allow for additional current flow and will increase the magnetic field generated by each of the loops to increase the starting force generated by the stacked printed circuit board layers. As described above, the copper traces may further be replaced by formed copper sheets. The formed copper sheets may be cut from thicker copper stock, to allow for additional current flow. Such increased force may be required for larger engines that have a greater mass associated with the crankshaft and pistons. In addition, the stamped copper sheets would increase the amount of current that can be generated when the electric device is operating as an alternator.

In yet another contemplated embodiment, the stacked printed circuit board electric device could be used to internally brake the engine in some applications, the stacked printed circuit board electric device may be configured to utilize the magnets of the flywheel to slow the rotation of the crankshaft when operation of the internal combustion engine 12 is terminated. Such braking system is desirable to stop rotation of the crankshaft as soon as possible after the engine has been turned off.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An electric device for an internal combustion engine including a crankshaft, comprising:
a rotor mounted to the crankshaft;
a plurality of printed circuit board layers oriented in a stacked relationship with each other and closely spaced from the rotor, wherein each of the printed circuit board layers comprises a number of loops that each create a magnetic field upon application of an electrical current to the loop;
a power supply selectively connectable to the circuit board layers to supply the electrical current to the loops in either a first direction or a second direction; and
a control unit operable to supply the electrical current from the power supply to the plurality of printed circuit board layers in alternating first and second directions, wherein the supply of electrical current to the plurality of printed circuit board layers induces rotation of the rotor via the created magnetic fields.

2. The electric device of claim 1 wherein the rotor is a flywheel mounted to the crankshaft having a number of permanent magnets spaced along a flywheel body.

3. The electric device of claim 2 wherein the ratio of permanent magnets of the flywheel to the number of loops on each of the printed circuit boards is 4:3.

4. The electric device of claim 1 wherein the power supply includes one or more batteries.

5. The electric device of claim 1 further comprising a number of switching devices connected between the power supply and the printed circuit board layers, wherein the control unit controls the operational state of the switching devices.

6. The electric device of claim 1 wherein each of the number of loops is a printed electrical trace on a substrate of the printed circuit board layer.

7. The electric device of claim 6 wherein a first printed trace type has a spiral pattern in a first direction and a second printed trace type has a spiral pattern in a second direction.

8. The electric device of claim 7 wherein the first printed trace type and the second printed trace type are alternately positioned along the substrate.

9. The electric device of claim 1 wherein each of the printed circuit boards includes a loop portion having a toroid shape and a control circuit portion.

10. The electric device of claim 9 wherein the control unit and the power supply are mounted on the control circuit portion.

11. The electric device of claim 1 further comprising a backing plate spaced from the stack of printed circuit board layers on an opposite side of the stack of printed circuit boards from the rotor.

12. The electric device of claim 11 wherein the backing plate includes a number of permanent magnets.

13. The electric device of claim 1 wherein the rotor comprises a number of magnets along a circumference of the rotor.

14. An electric device for use with an internal combustion engine including a crankshaft, comprising:
a rotor mounted to the crankshaft for rotation with the crankshaft;
a plurality of printed circuit board layers oriented in a stacked relationship with each other and closely spaced from the rotor, wherein each of the printed circuit board layers comprises a number of copper loops that each create a magnetic field upon application of an electrical current to the loop;
a power supply selectively connectable to supply the electrical current to the loops in either a first direction or a second direction;
a control unit configured to operate in one of a starter mode and an alternator mode, wherein the starter mode is configured to supply the electrical current from the power supply to the plurality of printed circuit board layers in alternating first and second directions, wherein the supply of current to the plurality of printed circuit board layers induces rotation of the rotor via the created magnetic field when the control unit is operation in the starter mode, and wherein
the alternator mode is configured to provide an induced current to a power converter connected to the circuit board layers to receive induced current from the loops upon rotation of the rotor over the stack of printed circuit board layers.

15. The electric device of claim 14 wherein the rotor is a flywheel mounted to the crankshaft having a number of permanent magnets spaced along a flywheel body.

16. The electric device of claim 15 wherein the ratio of permanent magnets of the flywheel to the number of loops on each of the printed circuit boards is 4:3.

17. The electric device of claim 14 further comprising a number of switching devices connected between the power supply and the printed circuit board layers, wherein the control unit controls the condition of the switching devices.

18. The electric device of claim 17 wherein the control unit controls the condition of the switching devices to switch between the starting mode and the alternator mode.

19. The electric device of claim 14 wherein each of the number of loops is a printed electrical trace on a substrate of the printed circuit board layer.

20. The electric device of claim 19 wherein a first printed trace type has a spiral pattern in a first direction and a second printed trace type has a spiral pattern in a second direction.

21. The electric device of claim 20 wherein the first printed trace type and the second printed trace type are alternately positioned along the substrate.

22. The electric device of claim 14 wherein each of the printed circuit boards includes a loop portion having a toroid shape and a mounting portion.

23. The electric device of claim 14 wherein the control unit and the power supply are mounted on the mounting portion.

24. The electric device of claim 14 further comprising a backing plate spaced from the stack of printed circuit boards on an opposite side of the stack of printed circuit boards from the flywheel.

25. The electric device of claim 24 wherein the backing plate includes a number of permanent magnets.

26. A starter motor for an internal combustion engine including a crankshaft, comprising:
a rotor mounted to the crankshaft;
a plurality of printed circuit board layers oriented in a stacked relationship with each other and closely spaced from the rotor, wherein each of the printed circuit board layers comprises a number of loops that each create a magnetic field upon application of an electrical current to the loop;
a power supply selectively connectable to the circuit board layers to supply the electrical current to the loops in either a first direction or a second direction; and
a control unit operable to supply the electrical current from the power supply to the plurality of printed circuit board layers in alternating first and second directions, wherein the supply of electrical current to the plurality of printed circuit board layers induces rotation of the rotor via the created magnetic fields.

27. The starter motor of claim 26 wherein the rotor is a flywheel mounted to the crankshaft having a number of permanent magnets spaced along an outer circumference of a flywheel body.

28. The starter motor of claim 26 further comprising a number of switching devices connected between the power supply and the printed circuit board layers, wherein the control unit controls the operational state of the switching devices.

29. The starter motor of claim 26 further comprising a backing plate spaced from the stack of printed circuit board layers on an opposite side of the stack of printed circuit board layers from the rotor.

30. The starter motor of claim 29 wherein the backing plate includes a number of permanent magnets.

31. The starter motor of claim 26 wherein the rotor comprises a number of magnets along a circumference of the rotor.
